(19) United States
(12) Patent Application Publication
(10) Pub. No.: US 2010/0089961 A1
(43) Pub. Date: Apr. 15, 2010

(54) APPARATUS AND METHOD OF CUTTING LIQUID CRYSTAL DISPLAY DEVICE

(76) Inventor: Sang-Sun SHIN, Gyeonggi-do (KR)

Correspondence Address: MORGAN LEWIS & BOCKIUS LLP, 1111 PENNSYLVANIA AVENUE NW, WASHINGTON, DC, 20004, US

(21) Appl. No.: 12/575,706

(22) Filed: Oct. 8, 2009

(30) Foreign Application Priority Data
Oct. 9, 2008 (KR) 10-2008-0099209

(51) Int. Cl. B26F 3/00; C03B 33/033

(52) U.S. Cl. 225/2; 225/96

(57) ABSTRACT

An apparatus for cutting a liquid crystal display (LCD) device is disclosed for a fast cutting of liquid crystal display panels, the apparatus including: a table on which a first mother substrate a second mother substrate having N×M (N,M≧2) liquid crystal display panels are loaded; a guide bar disposed at one side of the first and second mother substrates; and N scribing units each installed at the guide bar and configured to move along the guide bar to cut the first and second mother substrates, wherein each of the scribing units includes first and second supporting portions movable up and down along the guide bar, first and second rotational shafts installed at the first and second supporting portions, respectively, and first and second cutting members installed at the first and second rotational shafts, respectively, to cut the first and second mother substrates, respectively, in cooperation with the rotation of the rotational shafts, wherein the first and second cutting members of each scribing unit are installed such that a spacing therebetween is adjustable as wide as a width of a pad unit formed on the first mother substrate, wherein the first and second cutting members cutting the first and second mother substrates in an aligned state at one side of liquid crystal display panels where the pad unit is not formed, and simultaneously cut the first and second mother substrates with being spaced from each other by a width of the pad unit at another side of the liquid crystal display panels where the pad unit is formed.

### BACKGROUND OF THE INVENTION

1. Field of the Invention

The present invention relates to an apparatus and method for cutting a liquid crystal display device, and particularly, to an apparatus and method for cutting a liquid crystal display device allowing a fast separation of a liquid crystal display panel by cutting the liquid crystal display panels using a plurality of scribing units.

2. Background of the Invention

In general, liquid crystal display (LCD) devices display a desired image by individually supplying data signals depending on image information to liquid crystal cells arranged in a matrix array, thereby controlling respective light transmittances of the liquid crystal cells.

Therefore, the LCD device is provided with a liquid crystal display panel having liquid crystal cells arranged in matrix and an integrated circuit (IC) for driving the liquid crystal cells of the liquid crystal display panel.

The liquid crystal display panel includes a color filter substrate and a thin film transistor (TFT) array substrate facing each other, and a liquid crystal layer interposed between the color filter substrate and the TFT array substrate.

A plurality of data lines for sending data signals from a data driver IC to the liquid crystal cells and a plurality of gate lines for sending scan signals from a gate driver IC to the liquid crystal cells are formed on the TFT array substrate of the liquid crystal display panel so as to be orthogonal to each other. The liquid crystal cell is defined at each intersection between the data line and the gate line.

The gate driver IC supplies a scan signal sequentially to the plurality of gate lines so that the liquid crystal cells arranged in matrix are sequentially selected line by line. A data signal is supplied from the data driver IC to the selected line of the liquid crystal cells via the plurality of data lines.

Meanwhile, a common electrode and a pixel electrode are formed at inner surfaces of the color filter substrate and the TFT array substrate to face each other, so as to apply an electric field to the liquid crystal layer. Here, the pixel electrode is formed by each liquid crystal cell on the TFT array substrate, while the common electrode is integrally formed on the entire surface of the color filter substrate. Accordingly, a voltage applied to the pixel electrode is controlled in a state of a voltage being applied to the common electrode, thereby individually adjusting the light transmittances of the liquid crystal cells.

In order to control the voltage applied to the pixel electrode by each liquid crystal cell, each of the liquid crystal cells is provided with a thin film transistor (TFT) used as a switching device.

To improve yield in fabricating a liquid crystal display device, a plurality of TFT array substrates are formed on a large mother substrate and a plurality of color filter substrates are formed on a different mother substrate. The two mother substrates are then attached to each other so as to simultaneously form a plurality of liquid crystal display panels. Accordingly, a process of cutting the bonded mother substrates into unit liquid crystal display panels is needed.

Typically, the cutting (separation) the unit liquid crystal display panel is executed by a scribing process of forming scribing lines on the surfaces of the mother substrate by means of a cutting wheel formed of diamond having a hardness higher than that of glass, and a breaking process of cutting the mother substrate by applying a mechanical force along the scribing lines. Hereinafter, a typical liquid crystal display panel will be described in detail with reference to the accompanying drawings.

FIG. 1 shows a schematic plane structure of a unit liquid crystal display panel formed with a TFT array substrate and a color filter substrate of an LCD device attached to face each other.

Referring to FIG. 1, the liquid crystal display panel 10 includes an image display unit 13 having liquid crystal cells arranged in a matrix form, a gate pad unit 14 connected to gate lines of the image display unit 13, and a data pad unit 15 connected to data lines. Here, the gate pad unit 14 and the data pad unit 15 are formed at marginal portions of a TFT array substrate 1. The portion does not overlap with a color filter substrate 2. The gate pad unit 14 serves to supply a scan signal applied from a gate driver integrated circuit (IC) to the gate lines of the image display unit 13, and the data pad unit 15 serves to supply image information applied from a data driver IC to the data lines of the image display unit 13.

The data lines receiving the image information and the gate lines receiving the scan signal are disposed to be crossed orthogonally on the TFT array substrate 1 of the image display unit 13. AT the crossed portion, A thin film transistor (TFT) is formed at the crossed portion between the data line and the gate line for switching the liquid crystal cell, and a pixel electrode is formed to be connected to the TFT for driving the liquid crystal cell. Further, a passivation layer is formed at the entire surface for protecting the electrode and the TFT.

The color filter substrate 2 of the image display unit 13 is provided with color filters coated to be separated by cell regions with a black matrix, and a transparent common electrode is formed at the TFT array substrate 1.

The thusly defined TFT array substrate 1 and color filter substrate 2 face each other to maintain a preset cell gap therebetween and attached to each other by a sealant (not shown in the drawing) formed at the exterior of the image display unit 13. A liquid crystal layer (not shown in the drawing) is formed at the spacing defined between the TFT array substrate 1 and the color filter substrate 2.

FIG. 2 is an exemplary view showing a sectional structure of a plurality of liquid crystal display panels defined by attaching a first mother substrate having the TFT array substrate 1 and a second mother substrate having the color filter substrate 2.

Referring to FIG. 2, a plurality of unit liquid crystal display panels are formed such that one side of the TFT array substrate 1 protrudes more than the color filter substrate 2. This is because the gate pad unit 14 and the data pad unit 15, as shown in FIG. 1, are formed at the marginal portions of the TFT array substrate 1 where the TFT array substrate 1 and the color filter substrate 2 do not overlap.

Thus, the color filter substrate 2 formed on the second mother substrate 30 is formed by being spaced as far as a first dummy region 31, which corresponds to a protruded area of the TFT array substrate 1 formed on the first mother substrate 20.

Further, each of the unit liquid crystal display panels is appropriately arranged so as to use the first mother substrate 20 and the second mother substrate 30 as much as possible. In general, depending on a model, the unit liquid crystal display panels are generally formed to be isolated as much as the second dummy region 32.

After attaching the first mother substrate 20 having the TFT array substrate 1 and the second mother substrate 30 having the color filter substrate 2, the liquid crystal display panels are individually cut through a cutting process.

A cutting wheel is generally used to cut the substrate, which is shown in FIG. 3.

Referring to FIG. 3, the bonded first and second mother substrates 20 and 30 are loaded onto the first table 42 and a second table 44. Then, when a portion to be cut is placed at a spaced portion between the first and second tables 42 and 44, scribing lines 22 and 23 are formed on the first and second mother substrates 20 and 30 respectively through a first cutting wheel 50 and a second cutting wheel 52.

One side of the TFT array substrate formed on the first mother substrate 20 is formed to protrude more than the corresponding one side of the color filter substrate formed on the second mother substrate 30. This is resulted from the gate pad unit formed in a horizontal (right and left) direction of the TFT array substrate and the data pad unit formed in a vertical (up and down) direction, as shown in FIGS. 1 and 2.

Therefore, at the portion where the one side of the TFT array substrate protrudes more than the corresponding one side of the color filter substrate (i.e., a portion where a pad is formed), the first cutting wheel 50 is spaced from one side of a reference line R1 by a preset distance to thereby form the scribing line 22 on the surface of the first mother substrate 20, and the second cutting wheel 52 is spaced from the reference line R1 by a preset distance in an opposite direction to the first cutting wheel 50 to thereby form the scribing line 23 on the surface of the second mother substrate 30.

On the other hand, at a portion where the gate pad unit or the data pad unit is not formed on the TFT array substrate (i.e., a portion where the TFT array substrate does not protrude as compared to the color filter substrate), the first and second cutting wheels 50 and 52 are aligned with each other so as to form the scribing lines 22 and 23 on the surfaces of the first and second mother substrates 20 and 30, respectively.

In the meantime, a plurality of liquid crystal display panels are formed on the first and second mother substrates 20 and 30. Hence, in order to cut the first and second mother substrates 20 and 30 so as to be divided into a plurality of liquid crystal display panels, the first and second mother substrates 20 and 30 have to be scribed plural times to form a plurality of scribing lines 22 and 23 on the first and second mother substrates 20 and 30.

FIG. 4 shows the related art liquid crystal display panel cutting method for cutting mother substrates having a plurality of liquid crystal display panels formed thereon. Here, FIG. 4 shows mother substrates having 6 liquid crystal display panels (2×3=6).

The related art substrate cutting apparatus cuts the first mother substrate 20 and the second mother substrate 30 by means of a pair of cutting wheels disposed at upper and lower sides of the first and second substrates 20 and 30, respectively, accordingly a plurality of cutting processes are required to separate a plurality of divided liquid crystal display panels. In FIG. 4, the numerals [symbol] and [symbol] denote the order of cutting the first and second mother substrates 20 and 30 by use of the cutting wheels. That is, a cutting wheel initially located at the lower side is moved in a Y-direction along one side of the first mother substrate 20 so as to cut one side of the liquid crystal display panel formed on the first mother substrate 20 ( [symbol] ), and thereafter a cutting wheel located at the upper side is moved along one side of the second mother substrate 30 so as to cut one side of the liquid crystal display panels formed on the second mother substrate 30 ( [symbol] ). Here, because the pad units are formed at the first mother substrate 20 and accordingly the liquid crystal display panels formed on the first and second mother substrates 20 and 30 are different, the one side of the liquid crystal display panels are cut by driving the pair of cutting wheels individually.

Afterwards, opposite side of the liquid crystal display panels cut in the order of [symbol] and [symbol] are cut simultaneously by the pair of upper and lower cutting wheels. That is, due to non formation of a pad unit at this surface, since the side of the TFT array substrate on the first mother substrate 20 is located at the same position as the side of the color filter substrate on the second mother substrate 30, the upper and lower cutting wheels are aligned at the same position so as to cut the mother substrates 20 and 30 at the same time.

Afterwards, after continuously cutting the first and second mother substrates 20 and 30 in the order of [symbol] to [symbol] , the first and second mother substrates 20 and 30 are cut in an X-direction thereof. Even in the cutting process in the X-direction, as similar to the cutting in the vertical direction, when cutting the first and second mother substrates 20 and 30 along the side s having the pad units formed thereat, the upper and lower cutting wheels are independently driven to cut the first and second mother substrates 20 and 30, respectively. Also, when cutting the first and second mother substrates 20 and 30 along the side at which any pad unit is not formed, the upper and lower cutting wheels are driven simultaneously to cut the first and second mother substrates 20 and 30. As such, the horizontal cutting is executed in the order of [symbol] to [symbol] .

Consequently, in the related art liquid crystal display panel cutting method (in case of cutting the first and second mother substrates 20 and 30 having six sheets of liquid crystal display panels), the vertical cutting process should be performed six times and the horizontal cutting process should be performed 12 times. In other words, in order to cut one bonded substrates of the first and second mother substrates in the related art, the cutting wheels should e driven plural times, which becomes an importance cause of delaying the entire process. furthermore, the development of techniques demands on the formation of many liquid crystal display panels on a large mother substrate. However, the increase in the number of liquid crystal display panels on the mother substrate is inevitable for the increase in the number of times for driving the cutting wheels, resulting in further delay of the process.

### SUMMARY OF THE INVENTION

Therefore, to obviate the drawbacks and disadvantages of the related art, an object of the present invention is to provide an apparatus and method for cutting a liquid crystal display (LCD) device which allows a fast cutting process by cutting (scribing) liquid crystal display panels with a plurality of scribing units.

To achieve these and other advantages and in accordance with the purpose of the present invention, as embodied and broadly described herein, there is provided an apparatus including, a table on which a first mother substrate a second mother substrate having N×M (N,M≧2) liquid crystal display panels are loaded, a guide bar disposed at one side of the first and second mother substrates, and N scribing units each installed at the guide bar and configured to move along the guide bar to cut the first and second mother substrates, wherein each of the scribing units includes first and second supporting portions movable up and down along the guide bar, first and second rotational shafts installed at the first and second supporting portions, respectively, and first and second cutting members installed at the first and second rotational shafts, respectively, to cut the first and second mother substrates, respectively, in cooperation with the rotation of the rotational shafts, wherein the first and second cutting members of each scribing unit are installed such that a spacing therebetween is adjustable as wide as a width of a pad unit formed on the first mother substrate, wherein the first and second cutting members cutting the first and second mother substrates in an aligned state at one side of liquid crystal display panels where the pad unit is not formed, and simultaneously cut the first and second mother substrates with being spaced from each other by a width of the pad unit at another side of the liquid crystal display panels where the pad unit is formed. Here, the cutting members may include a cutting wheel or a laser.

In another aspect of the present invention, there is provided a method for cutting a liquid crystal device (LCD) device including, (a) preparing first and second mother substrates having N×M (N,M≧2) liquid crystal display panels, (b) disposing a cutting apparatus including N scribing units at a side of the first and second mother substrates, the N scribing units each having a first cutting member for scribing the first mother substrate and a second cutting member for scribing the second mother substrate, (c) moving the N scribing units along a guide bar to be located at corresponding positions conforming to N columns of liquid crystal display panels and simultaneously driving the N scribing units to scribe the liquid crystal display panels in the column direction, (d) moving the first and second mother substrates to align a first scribing unit at a side of a first row of liquid crystal display panels, and thereafter moving the first scribing unit in the row direction in an aligned state of the first and second cutting members of the first scribing unit so as to scribe the first and second mother substrates, (e) moving the first and second mother substrates to align a second scribing unit at another side of a M^{th} row of liquid crystal display panels, and thereafter moving the first scribing unit in the row direction by aligning the first and second cutting members of the second scribing unit with a preset gap therebetween so as to scribe the first and second mother substrates in the spaced state by the preset gap, and (f) repeating the steps (d) and (e) at least once.

The present invention may allow a fast cutting process owing to the cutting (scribing) by employing a plurality of scribing units.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a planar view of a schematic structure of a typical LCD device;

FIG. 2 is a cross-sectional view showing mother substrates having a plurality of liquid crystal display panels;

FIG. 3 is a view showing the related art cutting apparatus of liquid crystal display panels;

FIG. 4 is a view showing the order of scribing the mother substrates of liquid crystal display panels;

FIGS. 5a and 5b are views showing a cutting apparatus and a structure of an LCD device in accordance with the present invention;

FIG. 6 is a view showing the order of X-direction scribing of the LCD device in accordance with the present invention;

FIG. 7 is a view showing the order of Y-direction scribing of an LCD device in accordance with a first embodiment of the present invention;

FIG. 8 is a view showing the order of Y-direction scribing of an LCD device in accordance with a second embodiment of the present invention;

FIG. 9 is a view showing the order of Y-direction scribing of an LCD device in accordance with a third embodiment of the present invention;

FIG. 10 is a view showing the order of Y-direction scribing of an LCD device in accordance with a fourth embodiment of the present invention;

FIG. 11 is a view showing the order of Y-direction scribing of an LCD device in accordance with a fifth embodiment of the present invention; and

FIG. 12 is a view showing the order of Y-direction scribing of an LCD device in accordance with a sixth embodiment of the present invention.

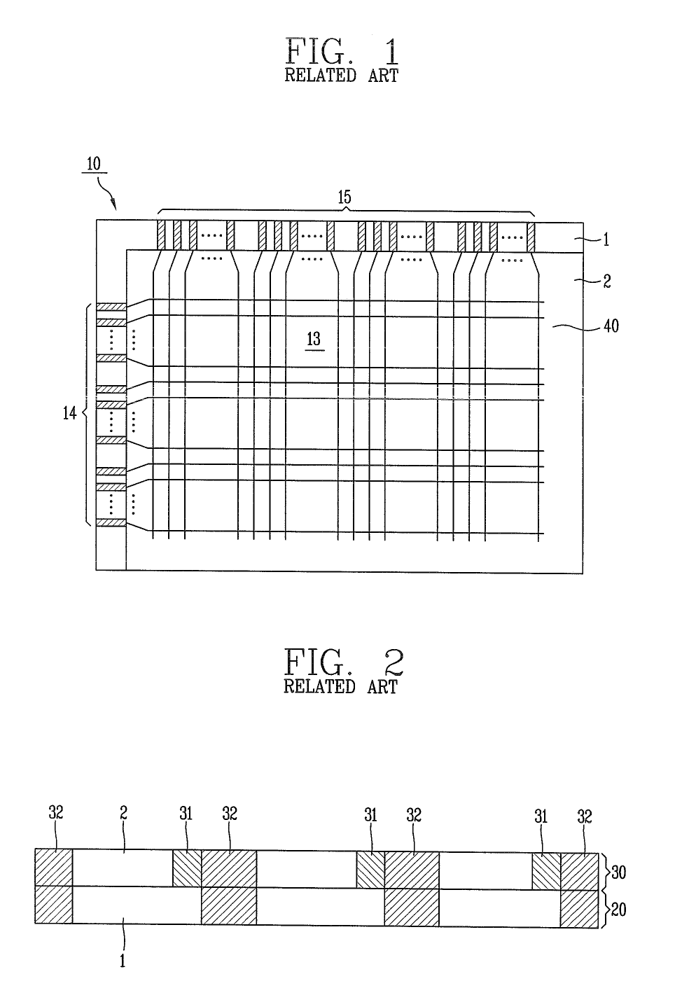

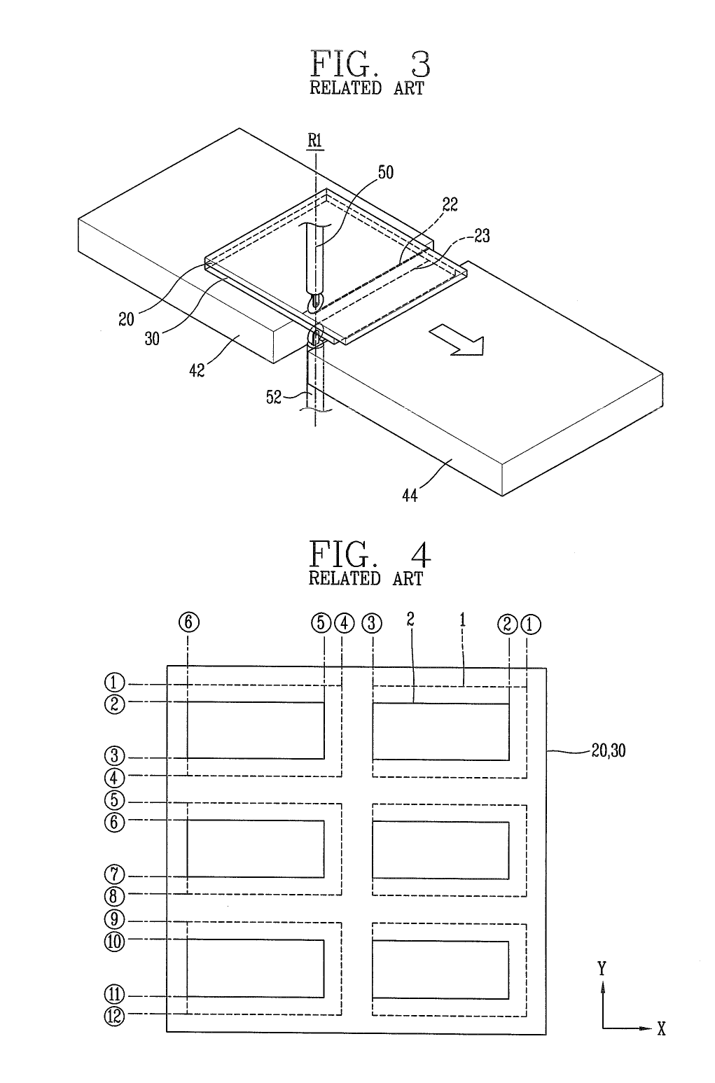

### DETAILED DESCRIPTION OF THE INVENTION

Description will now be given in detail of the present invention, with reference to the accompanying drawings.

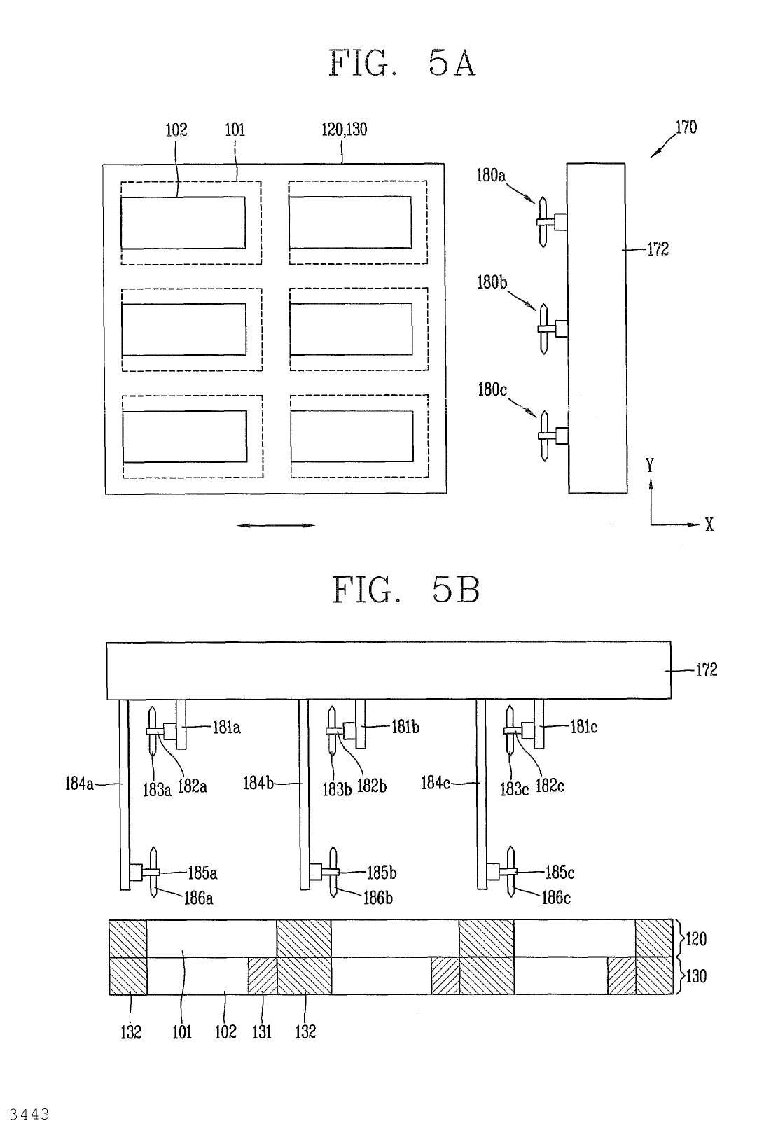

FIGS. 5a and 5b are views showing a cutting apparatus 170 of an LCD device in accordance with the present invention. As shown in FIG. 5a, the cutting apparatus 170 according to the present invention may include a plurality of first to third scribing units 180a, 180b and 180c, and a guide bar 172 on which the scribing units 180a, 180b and 180c are installed. The first to third scribing units 180a, 180b and 180c are typically the same as the number of columns (or rows) of liquid crystal display panels formed on the first and second mother substrates 120 and 130. Each of the scribing units 180a, 180b and 180c cuts the first and second mother substrates 120 and 130 along side s of the liquid crystal display panels arranged on each column (or row); however, the number of scribing units 180a, 180b and 180c are not limited. Also, although the liquid crystal display panels are arranged in 2×3 arrangement on the first and second mother substrates 120 and 130 and three scribing units 180a, 180b and 180c are provided in the drawing; however, this is for the sake of explanation and the number of liquid crystal display panels and the number of scribing units may not be limited to those in the present invention. However, for the cutting efficiency, if N×M (here, N,M≧2) liquid crystal display panels are arranged on the mother substrates 120 and 130, preferably, N scribing units may be provided; however, the number of scribing units may also not be limited.

Referring to FIG. 5b, the scribing unit 180a may include a first supporting portion 181a installed at the guide bar 172, a first rotational shaft 182a rotatably installed at the first supporting portion 181a, a first cutting wheel 183a rotated in cooperation with the rotation of the first rotational shaft 182a for forming a scribing line on a mother substrate, a second supporting portion 184a installed at the guide bar 172, a second rotational shaft 185a rotatably installed at the second supporting portion 184a, and a second cutting wheel 186a rotated in cooperation with the rotation of the second rotational shaft 185a for forming a subscribing line on a mother substrate.

The first supporting portion 181a, the first rotational shaft 182a and the first cutting wheel 183a cooperate to scribe the first mother substrate 120 so as to form the scribing line thereon, while the second supporting portion 184a, the second rotational shaft 185a and the second cutting wheel 185a cooperate to scribe the second mother substrate 130 so as to form the scribing line thereon. The first and second supporting portions 181a and 184a may be installed at the guide bar 172 to be movable up and down and also movable along the guide bar 172. Further, the first and second supporting portions 181a and 184a may be installed at the guide bar 172 to be freely rotatable. That is, when a load is applied to the first and second supporting portions 181a and 184a, the first and second supporting portions 181a and 184a are rotated.

Although not shown, the first mother substrate 120 denotes a TFT array substrate 102. A plurality of pixel regions are defined on the liquid crystal display panel of the first mother substrate 120. A TFT and a pixel electrode are formed at each pixel region. Also, the second mother substrate 130 denotes a color filter substrate 102. A color filter is formed on the liquid crystal display panel of the second mother substrate 130. The TFT array substrate 101 and the color filter substrate 102 maintain a preset cell gap by facing each other. Then, the TFT array substrate 101 and the color filter substrate 102 are attached to each other by a sealant (not shown in the drawing) formed at the exterior of an image display unit, and a liquid crystal layer (not shown in the drawing) is formed in the spacing between the TFT array substrate 101 and the color filter substrate 102.

The liquid crystal display panel is configured such that one side of the TFT array substrate 101 protrudes further than the color filter substrate 102 and a gate pad unit and a data pad unit are formed at the marginal portion of the TFT array substrate 101. That is, the color filter substrate 102 formed on the second mother substrate 130 is spaced apart by a first dummy region 131 corresponding to a protruded area of the TFT array substrate 101 formed on the first mother substrate 120 so that the gate pad unit and the data pad unit are formed on the spaced region. The gate pad unit and the data pad unit serve to connect external gate driving circuit and data driving circuit to a pixel unit of the liquid crystal display panel. A signal is applied to the TFT and the pixel electrode of the liquid crystal display panel via a gate pad and a data pad disposed at the gate pad unit and the data pad unit.

In the meanwhile, liquid crystal display panels are formed to be spaced from one another by a second dummy region 132 so as to use the first and second mother substrates 120 and 130 as much as possible.

The plurality of scribing units 180a, 180b and 180c installed at the guide bar 172 are moved in a Y-direction along the guide bar 172. A table (not shown), on which the first and second mother substrates 101 and 102 are loaded, or the guide bar 172 is moved in an X-direction, to thereby cut the first and second mother substrate 120 and 130.

Hereinafter, a method for cutting the first and second mother substrates 120 and 130 using the above cutting apparatus will be described in detail.

Referring to FIGS. 5a and 5b, the first mother substrate 120 and the second mother substrate 130 are loaded on a table (not shown) of the cutting apparatus 170 having the plurality of scribing units 180a, 180b and 180c. The plurality of scribing units 180a, 180b and 180c are moved along the guide bar 172 to be aligned at positions to cut the first and second mother substrates 120 and 130.

Afterwards, the first supporting portion 181a is moved downwardly so that the first cutting wheel 183a comes in contact with the first mother substrate 120 or the second supporting portion 184a is moved upwardly so that the second cutting wheel 186a comes in contact with the second mother substrate 130. In this state, the first cutting wheel 183a and/or the second cutting wheel 186a are driven.

As aforesaid, in the state where the first cutting wheel 183a and/or the second cutting wheel 186a come in contact with the first mother substrate 120 and/or the second mother substrate 130 and then the first cutting wheel 183a and/or the second cutting wheel 186a are driven, the table is moved in the X-direction so as to form a scribing line(s) on the first mother substrate 120 and/or the second mother substrate 130 in the X-direction.

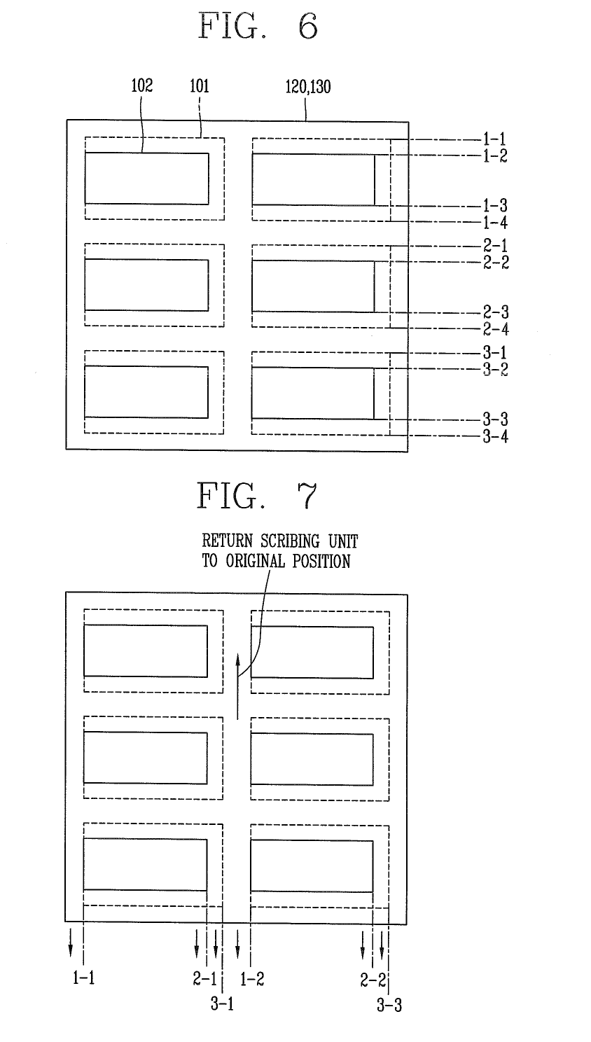

FIG. 6 shows the order of forming the scribing line(s) on the first mother substrate 120 and/or the second mother substrate 130 in the X-direction by use of the cutting apparatus 170. Here, the former numeral denotes the numeral of a cutting wheel and the latter numeral denotes the cutting order (sequence) by the corresponding cutting wheel.

As shown in FIG. 6, three scribing units 180a, 180b and 180c scribe liquid crystal display panels arranged in a column among liquid crystal display panels arranged in matrix (2×3), thereby forming scribing lines. That is, each of the three scribing units 180a, 180b and 180c is driven in a state of being in contact with one side of the TFT array substrate 101 of each column of liquid crystal display panels, thereby forming scribing lines 1-1, 2-1 and 3-1 on the corresponding side. Afterwards, the scribing units 180a, 180b and 180c are moved along the guide bar 172 to come in contact with one side of the color filter substrate 102 of a column of the liquid crystal display panels. In this state, the scribing units 180a, 180b and 180c are driven to form scribing lines 1-2, 2-2 and 3-2 on the corresponding side.

The scribing units 180a, 180b and 180c are then moved along the guide bar 172 to come in contact with another side of the TFT array substrate 101 of a column of liquid crystal display panels. In this state, the scribing units 180a, 180b and 180c are driven to form scribing lines 1-3, 2-3 and 3-3 on the corresponding side. Afterwards, the scribing units 180a, 180b and 180c are moved along the guide bar 172 so as to form scribing lines 1-4, 2-4 and 3-4 on another side of the color filter substrate 102 of the column of liquid crystal display panels.

As such, the scribing units 180a, 180b and 180c are employed to scribe three columns of liquid crystal display panels in the X-direction, thereby forming the scribing lines in the X-direction by the four-time cutting process. Hence, the number of processes can be reduced as compared to the related art that forms the scribing lines through the 12-time cutting process by employing one scribing unit.

In the meantime, the Y-direction cutting of the first and second mother substrates 120 and 130 are executed by moving the scribing units 180a, 180b and 180c in the Y-direction along the guide bar 172. The scribing of the first and second mother substrates 120 and 130 in the Y-direction may be achieved by various embodiments as follows.

Here, the supporting portions 181a, 181b and 181c of the scribing units 180a, 180b and 180c are rotatably installed at the guide bar 172. Accordingly, if the scribing units 180a, 180b and 180c are moved in the Y-direction, in a state where the cutting wheels come in contact with the first and second mother substrates 120 and 130 to scribe the first and second mother substrates 120 and 130 in the Y-direction after scribing the first and second mother substrates 120 and 130 in the X-direction, a load is applied to each of the supporting portions 181a, 181b and 181c to rotate the same, whereby the blades of the cutting wheels are fixed with facing the Y-direction. As such, if the scribing units 180a, 180b and 180c are moved in the Y-direction in the state of the cutting wheels being fixed, the first and second mother substrates 120 and 130 may be scribed.

First of all, FIG. 7 is a view showing the order of scribing the first and second mother substrates 120 and 130 in the Y-direction in accordance with a first embodiment.

As shown in FIG. 7, this embodiment specifies that one scribing unit scribes a side of each liquid crystal display panel in a Y-direction so as to form a scribing line. That is, the table is moved such that the guide bar 172 is located at one side of a row of liquid crystal display panels on the first and second mother substrates 120 and 130. The first scribing unit 180a of the plurality of scribing units 180a, 180b and 180c is driven so as to form a scribing line 1-1 on one side of a first row of liquid crystal display panels. Here, after the first cutting wheel 183a of the first scribing unit 180a is moved downwardly to come in contact with the first mother substrate 120 and the second cutting wheel 186a is moved upwardly to come in contact with the second mother substrate 130, the first cutting wheel 183a and the second cutting wheel 186a are simultaneously driven, thereby forming scribing lines simultaneously on the first and second mother substrates 120 and 130. Here, since one side of the liquid crystal display panels is a portion where any pad region is not formed, the TFT array substrate 101 and the color filter substrate 102 form the same side sectional surface. Hence, one side of the TFT array substrate 101 and one side of the color filter substrate 102 are simultaneously processed after aligning the first cutting wheel 182a and the second cutting wheel 186a in a row.

Afterwards, the table is moved so that the guide bar 172 is located at another side of the liquid crystal display panels arranged in a row on the first and second mother substrates 120 and 130, and then the second scribing unit 180b of the plurality of scribing units 180a, 180b and 180c is driven so as to form a scribing line on another side of the first row of liquid crystal display panels. Here, in the state where the second cutting wheel 186b of the second scribing unit 180b is moved upwardly to come in contact with the second mother substrate 130, the second cutting wheel 186b is driven so as to form a scribing line 2-1 on the second mother substrate 130.

After moving the table again, the third cutting wheel 186c of the third scribing unit 180c is driven to form a scribing line 3-1 on the first mother substrate 120 at another side of the first row of plurality of liquid crystal display panels.

As such, this embodiment specifies that the plurality of scribing units 180a, 180b and 180c installed at the guide bar 172 are sequentially used to scribe a row of liquid crystal display panels, and then the plurality of scribing units 180a, 180b and 180c are sequentially used in the same manner to scribe the succeeding row of liquid crystal display panels so as to form the scribing lines. Here, the scribing units used for scribing the first row of liquid crystal display panels are returned to their original positions, and thereafter scribe the second row of liquid crystal display panels in the same manner as the previous process so as to form the scribing lines on the first and second mother substrates 120 and 130.

Consequently, the plurality of scribing units 180a, 180b and 180c are sequentially used, accordingly, the cutting wheels 183a, 183b, 183c, 186a, 186b and 186c of the scribing units 180a, 180b and 180c are evenly used, resulting in prevention of abrasion of specific cutting wheels due to excessive uses thereof.

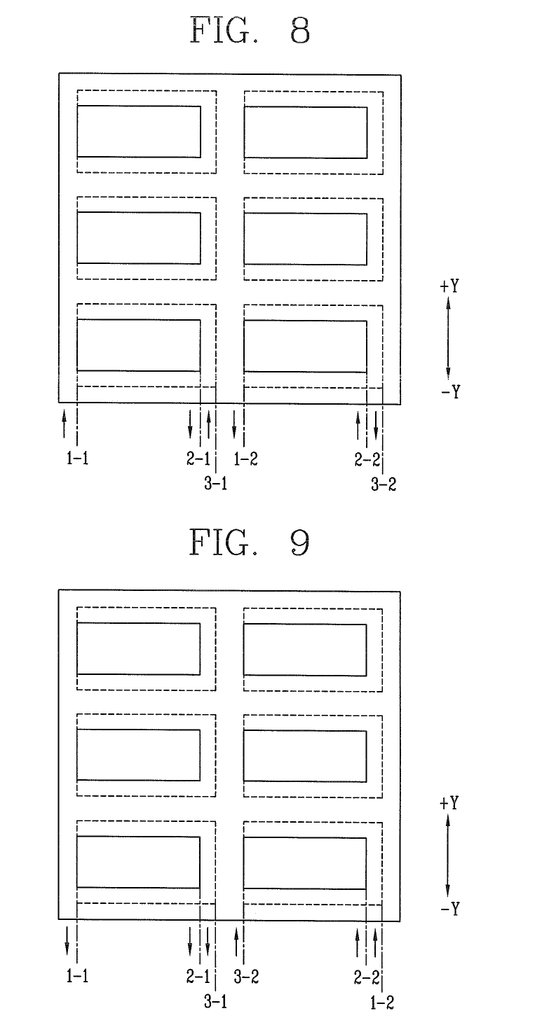

FIG. 8 is a view showing the order of scribing the first and second mother substrate in the Y-direction in accordance with a second embodiment.

The scribing order of this embodiment shown in FIG. 8 is the same as that in FIG. 7, excluding a proceeding direction of the scribing units 180a, 180b and 180c. That is, the first embodiment shown in FIG. 7 has specified that the scribing units 180a, 180b and 180c are uni-directionally moved along the Y-direction, while the second embodiment specifies that the scribing units 180a, 180b and 180c are alternately moved in an opposite direction to scribe the first and second mother substrates 120 and 130.

That is, referring to FIG. 8, when the cutting wheels 183a and 186a of the first scribing unit 180a are moved in the −Y-direction along the guide bar 172 in a state of being contacted with the first and second mother substrates 120 and 130, respectively, so as to form a scribing line 1-1 on one side of a row of liquid crystal display panels, the second scribing units 180b and the third scribing units 180c which are not actually participated in the scribing are also moved in the −Y-direction along the guide bar 172. Here, the cutting wheels of the second scribing unit 180b and the third scribing unit 180c are moved in a non-contact state with the first and second mother substrates 120 and 130.

Afterwards, after moving the table in the X-direction, the second scribing unit 180b is moved in a +Y-direction along the guide bar 172 in a state where the second cutting wheel 186b of the second scribing unit 180b comes in contact with the second mother substrate 130, thereby forming a scribing line 2-1 on the second mother substrate 130 at another side of the liquid crystal display panels. Even in this time, the cutting wheels of the first scribing unit 180a and the third scribing unit 180c are moved in the Y-direction under a non-contact state with the first and second mother substrates 120 and 130. Afterwards, such processes are repeated so as to form the scribing lines on the first and second mother substrates 120 and 130.

Consequently, the second embodiment sequentially uses the plurality of scribing units 180a, 180b and 180c so as to evenly use the cutting wheels 183a, 183b, 183c, 186a, 186b and 186c of the scribing units 180a, 180b and 180c, resulting in prevention of abrasion of specific cutting wheels due to excessive uses thereof. In addition, non-requirement of the returning process of the scribing units 180a, 180b and 180c allows the faster scribing process.

FIG. 9 is a view showing the order of scribing the first and second mother substrates 120 and 130 in the Y-direction in accordance with a third embodiment.

The cutting order shown in FIG. 9 is the same as that of the first embodiment shown in FIG. 7, excluding that the returning process for the scribing units 180a, 180b and 180c is not required unlike in the first embodiment in which the returning thereof is needed.

Therefore, the first scribing unit 180a, the second scribing unit 180b and the third scribing unit 180c are sequentially moved in a −Y-direction along the guide bar 172 to scribe the first row of liquid crystal display panels. Here, the scribing units 180a, 180b and 180c having moved from one end portion of the guide bar 172 to another end portion in the −Y-direction are located at the another end portion of the guide bar 172 in the order of the first scribing unit 180a, the second scribing unit 180b and the third scribing unit 180c (i.e., in the order that the first scribing unit 180a is located the closest to the side of the mother substrates and the third scribing unit 180c is located close to a central area of the mother substrates). The scribing of the second row of liquid crystal display panels is executed in a reverse order of the scribing units 180a, 180b and 180c, namely, starting from the third scribing unit 180c located at the central side of the mother substrates, so that the mother substrates 120 and 130 are scribed in the order of the third scribing unit 180c, the second scribing unit 180b and the first scribing unit 180a. That is, the scribing units 180a, 180b and 8180c scribe the second row of liquid crystal display panels while moving along the guide bar 172 in the order of the third scribing unit 180c, the second scribing unit 180b and the first scribing unit 180a.

The third embodiment also sequentially uses the plurality of scribing units 180a, 180b and 180c so as to evenly use the cutting wheels 183a, 183b, 183c, 186a, 186b and 186c of the scribing units 180a, 180b and 180c, resulting in prevention of abrasion of specific cutting wheels due to excessive uses thereof. In addition, non-requirement of the returning process of the scribing units 180a, 180b and 180c allows the faster cutting process.

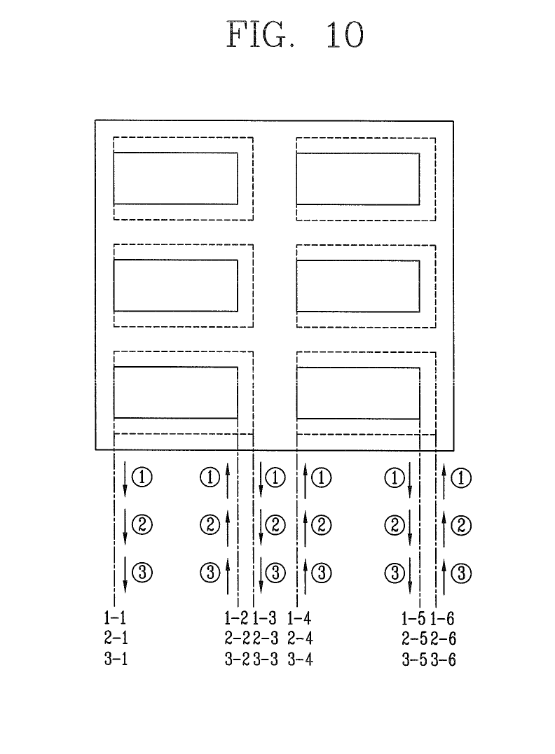

FIG. 10 is a view showing the order of scribing the first and second mother substrates 120 and 130 in the Y-direction in accordance with a fourth embodiment.

The scribing method shown in the fourth embodiment is a region-splitting scribing method, in which the three scribing units 180a, 180b and 180c are used to scribe corresponding liquid crystal display panels arranged in each row. That is, referring to FIG. 10, the guide bar 172 is aligned with one side of a row of liquid crystal display panels formed on the first and second mother substrates 120 and 130 and then first scribing lines 1-1, 2-1 and 3-1 are formed on the first and second mother substrates 120 and 130 by means of the first to third scribing units 180a, 180b and 180c. Here, the first scribing unit 180a scribes the first and second mother substrates 120 and 130 at one side of the first liquid crystal display panel of one row of liquid crystal display panels to form a scribing line [symbol] , the second scribing unit 180b scribes the first and second mother substrates 120 and 130 at one side of the second liquid crystal display panel of the one row of liquid crystal display panels to form a scribing line [symbol] , and the third scribing unit 180c scribes the first and second mother substrates 120 and 130 at one side of the third liquid crystal display panel of the one row of liquid crystal display panels to form a first scribing line [symbol] . Here, each of the first to third scribing units 180a, 180b and 180c is simultaneously driven so as to simultaneously scribe one side of the liquid crystal display panels on the corresponding regions, thereby forming each of the scribing lines 1-1, 2-1 and 3-1.

Afterwards, in a state where the table is moved so that the guide bar 172 is aligned with another side of the one row of liquid crystal display panels, the first to third scribing units 180a, 180b and 180c are simultaneously driven on the corresponding region in an opposite direction to the direction of forming the first scribing line, thereby forming second cutting lines 1-2, 2-2 and 3-2.

Such scribing process is repeated to form the plurality of scribing lines on the first and second mother substrates 120 and 130, thereby dividing the mother substrates into a plurality of liquid crystal display panels.

Here, the fourth embodiment specifies that one scribing unit is driven plural times in a split region so as to scribe the first and second mother substrates 120 and 130 of the corresponding region. Here, each scribing unit goes and returns within the corresponding region to scribe the mother substrates 120 and 130, and accordingly the returning of the scribing units to their original positions is not required. In particular, in this embodiment, the plurality of scribing units are simultaneously driven to simultaneously scribe the first and second mother substrates 120 and 130, resulting in remarkable improvement of the speed of scribing the first and second mother substrates 120 and 130.

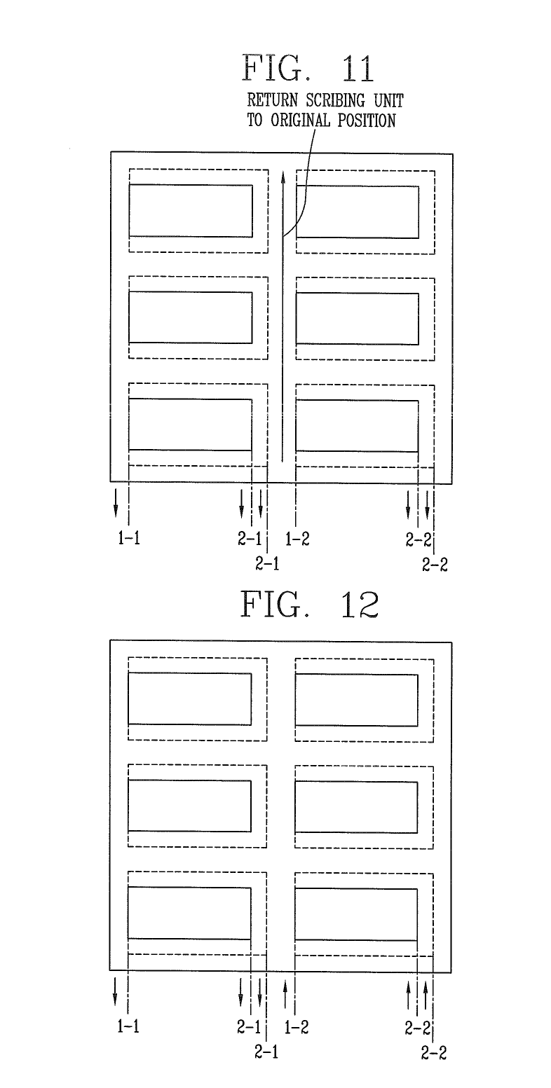

FIG. 11 is a view showing the order of scribing the first and second mother substrates 120 and 130 in the Y-direction in accordance with a fifth embodiment.

The scribing order of the fifth embodiment is a chasing scribing method, in which one scribing unit simultaneously scribes the first and second mother substrates 120 and 130 at a side at which pad regions of the liquid crystal display panels are formed.

That is, referring to FIG. 11, the side of the liquid crystal display panel without a pad region formed thereat is scribed by two cutting wheels disposed at a scribing unit, and another side of the liquid crystal display panel having a pad region is also scribed by two wheels disposed at one scribing unit. Here, since scribing lines on the first and second mother substrates 120 and 130 are formed on the same position at the side of the liquid crystal display panel without the pad region, two cutting wheels are moved up and down in an aligned state and driven after coming in contact with the first and second mother substrates 120 and 130, while the scribing lines on the first and second mother substrates 120 and 130 are formed on the different positions at the pad region-formed side of the liquid crystal display panel and accordingly two cutting wheels of the scribing unit should be spaced from each other by a preset gap.

Referring back to FIG. 5b, the guide bar 172 is provided with the first and second supporting portions 181a and 184a, which respectively support the first rotational shaft 182a and the second rotational shaft 182b rotating the respective first cutting wheel 183a and second cutting wheel 186a. Although not shown in the drawing, the first supporting portion 181a and the second supporting portion 184a are movable installed on the guide bar 172. Hence, the first and second supporting portions 181a and 184a are minutely moved so that the first cutting wheel 183a and the second cutting wheel 186a can be spaced apart from each other and additionally the spacing therebetween can be adjusted.

Furthermore, instead of moving the first and second supporting portions 181a and 184a at the guide bar 172, the first rotational shafts 182a and 182b may be movably installed at the first and second supporting portions 181a and 184a or the first and second cutting wheels 183a and 186a may be movably installed at the first and second rotational shafts 182a and 182b, thereby adjusting the spacing between the first and second cutting wheels 183a and 186a.

As such, after adjusting the spacing between two cutting wheels provided at one scribing unit (i.e., after aligning each of the cutting wheels at a position of a scribing line to be formed on the first mother substrate 120 and a position of a scribing line to be formed on the second mother substrate 130), if the corresponding cutting wheels are driven, the first and second mother substrates 120 and 130 may be simultaneously scribed. Here, the two cutting wheels may proceed simultaneously in −Y or +Y-direction or with a preset interval (i.e., time interval).

Thus, the first and second mother substrates 120 and 130 can be simultaneously scribed by one scribing unit, so the scribing method in accordance with this embodiment allows the remarkable shortening of the scribing process.

FIG. 12 is a view showing the order of scribing the first and second mother substrates 120 and 130 in the Y-direction in accordance with a sixth embodiment.

The scribing order of this embodiment is the same as that of the fifth embodiment, excluding that the fifth embodiment specifies that in a state where the scribing unit is returned to its original position after scribing a row of liquid crystal display panels, the scribing unit proceeds in the same direction to scribe another row of liquid crystal display panels, while this embodiment specifies that a scribing unit having scribed a row of liquid crystal display panels proceeds in an opposite direction to the initial direction without being returned to its original position so as to scribe liquid crystal display panels.

Similar to the fifth embodiment, this embodiment is implemented to simultaneously scribe the first and second mother substrates 120 and 130 by one scribing unit. Hence, the scribing method according to this embodiment allows the remarkable shortening of the scribing process, and also the scribing unit does not have to be returned to the original position so as to further shorten the scribing process.

In the meantime, the foregoing description of the liquid crystal display panel scribing process has been given by exemplarily employing cutting wheels as a scribing unit; however, the present invention may not be limited to the cutting wheels. Any device, e.g., a laser, employed to cut a glass substrate may be applicable to the present invention.

As such, after forming scribing lines on the first and second mother substrates 120 and 130, a pressure is applied onto the scribing lines by use of a pressure applying member, such as a pressing rod, to thus separate liquid crystal display panels from the mother substrates 120 and 130. Also, the separated liquid crystal display panels are conveyed to the succeeding process by a transfer unit having an adsorption plate.

As described above, the present invention is provided with a plurality of scribing units, so that the X-direction scribing can be achieved by simultaneously driving the plurality of scribing units, and the Y-direction scribing can be achieved by sequentially driving, simultaneously driving for each region or simultaneously driving the plurality of scribing units, resulting in a fast processing for the mother substrates.

The above description has been given of the preset number of liquid crystal display panels being formed on the mother substrates and a specific configuration being provided as a cutting apparatus, but the present invention may be applicable to various numbers or structures without being construed to be limited to the preset number of liquid crystal display panels or the specific configuration of the cutting apparatus. That is, another embodiment or variations of the present invention may be easily derived by any person skilled in the art that the present invention belongs to by applying the basic concept of the present invention.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An apparatus for cutting a liquid crystal display (LCD) device comprising:
a table on which a first mother substrate and a second mother substrate having N xM (N,M≧2) liquid crystal display panels are loaded;
a guide bar at one side of the first and second mother substrates; and
N scribing units each installed at the guide bar and configured to move along the guide bar to scribe the first and second mother substrates,
wherein each of the scribing units comprises first and second supporting portions moving along the guide bar and to be lifted and lowered, first and second rotational shafts installed respectively at the first and second supporting portions, and first and second cutting members installed respectively at the first and second rotational shafts to scribe respectively the first and second mother substrates in accordance with the rotation of the rotational shafts,
wherein the first and second cutting members of each scribing unit are installed at the first and second rotational shafts such that a spacing therebetween is adjustable as wide as a width of a pad unit formed on the first mother substrate, thereby the first and second cutting members scribe the first and second mother substrates in an aligned state at one side of liquid crystal display panels where a pad unit is not formed while simultaneously scribing the first and second mother substrates with being spaced from each other by a width of a pad unit at another side of the liquid crystal display panels where the pad unit is formed, thereby forming scribing lines.

2. The apparatus of claim 1, wherein the cutting member includes at least one of a cutting wheel and a laser.

3. The apparatus of claim 1, further comprising:
a pressure applying member for applying pressure to the scribing lines to separate the cut liquid crystal display panels; and
a transfer member for transferring the separated liquid crystal display panels.

4. A method for cutting a liquid crystal device (LCD) device comprising:
(a) preparing first and second mother substrates having N×M (N,M≧2) liquid crystal display panels;
(b) disposing a cutting apparatus including N scribing units at a side of the first and second mother substrates, the N scribing units each including a first cutting member for scribing the first mother substrate and a second cutting member for scribing the second mother substrate;
(c) moving the N scribing units along a guide bar to be located at corresponding positions conforming to N columns of liquid crystal display panels and simultaneously driving the N scribing units to scribe the liquid crystal display panels in the column direction;
(d) moving the first and second mother substrates to align a first scribing unit at a side of a first row of liquid crystal display panels, and thereafter moving the first scribing unit in the row direction in an aligned state of the first and second cutting members of the first scribing unit so as to scribe the first and second mother substrates;
(e) moving the first and second mother substrates to align a second scribing unit at another side of a M^{th} row of liquid crystal display panels, and thereafter moving the first scribing unit in the row direction by aligning the first and second cutting members of the second scribing unit with a preset gap therebetween so as to scribe the first and second mother substrates in the spaced state by the preset gap; and
(f) repeating the steps (d) and (e) at least once.

5. The method of claim 4, wherein upon the scribing of the steps (d) and (e), the scribing units move in opposite directions to each other along the guide bar.

6. The method of claim 4, further comprising:
returning the N scribing units to the original positions thereof along the guide bar; and
repeating the steps (d), (e) and (f).

7. The method of claim 4, wherein the cutting member includes at least one of a cutting wheel and a laser.

8. A method for cutting a liquid crystal display (LCD) device comprising:
(a) preparing first and second mother substrates having N×M (N,M≧2) liquid crystal display panels;
(b) disposing a cutting apparatus including N scribing units at a side of the first and second mother substrates, the N scribing units each including a first cutting member for scribing the first mother substrate and a second cutting member for scribing the second mother substrate;
(c) moving the N scribing units along a guide bar to be located at corresponding positions conforming to N columns of liquid crystal display panels and simultaneously driving the N scribing units to scribe the liquid crystal display panels in the column direction;
(d) moving the first and second mother substrates to align the guide bar at a side of a first row of liquid crystal display panels, and moving the N scribing units along the guide bar to be located at corresponding liquid crystal display panels, respectively;
(e) simultaneously driving the N scribing units such that each of the N scribing units simultaneously scribes one side of the corresponding liquid crystal display panel;
(f) moving the first and second mother substrates to align the guide bar at another side of the first row of liquid crystal display panels, and simultaneously driving the N scribing units so that each of the N scribing units simultaneously scribes another side of the corresponding liquid crystal display panel; and
(g) repeating the step (f).

9. The method of claim 8, wherein upon the scribing of the N scribing units of the steps (e) and (f), the scribing units move in opposite directions to each other along the guide bar.

10. A method for cutting a liquid crystal display (LCD) device comprising:
(a) providing first and second mother substrates having N×M (N,M≧2) liquid crystal display panels;
(b) disposing a cutting apparatus including N scribing units at a side of the first and second mother substrates, the N scribing units each including a first cutting member for scribing the first mother substrate and a second cutting member for scribing the second mother substrate;
(c) moving the N scribing units along a guide bar to be located at corresponding positions conforming to N columns of liquid crystal display panels and simultaneously driving the N scribing units to scribe the liquid crystal display panels in the column direction;
(d) moving the first and second mother substrates to align a first scribing unit at a side of a first row of liquid crystal display panels, and thereafter moving the first scribing unit in the row direction by aligning the first and second cutting members of the first scribing unit so as to scribe the first and second mother substrates;
(e) moving the first and second mother substrates to align a second scribing unit at another side of a M^{th} row of liquid crystal display panels, and thereafter moving the first cutting member of the second scribing unit in the row direction so as to scribe the first mother substrate;
(f) moving the first and second mother substrates and moving the second cutting member of the second scribing unit in the row direction so as to cut the second mother substrate; and
(g) repeating the steps (d), (e) and (f) at least once.

11. The method of claim 10, wherein upon the scribing of the steps (d), (e) and (f), the scribing units alternately move in opposite directions to each other along the guide bar.

12. The method of claim 10, wherein the repetition of the steps (d), (e) and (f) is executed after returning the N scribing units to the original positions thereof along the guide bar.
